(19) United States
(12) Patent Application Publication
(10) Pub. No.: US 2009/0048746 A1
(43) Pub. Date: Feb. 19, 2009

(54) Vehicle cruise control apparatus

(75) Inventor: Masato Kaigawa, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/498,082

(22) Filed: Aug. 3, 2006

(30) Foreign Application Priority Data
Aug. 4, 2005 (JP) 2005-227092

(51) Int. Cl. G06F 7/00

(52) U.S. Cl. 701/54

(57) ABSTRACT

A vehicle cruise control apparatus is provided. The vehicle has an engine 2 mounted thereon, a function of implementing constant-speed-cruise control and transmission control. The apparatus includes demand value computation section 14, engine control section 16, expected value computation section 12, compensation section 18 and AI-shift control section 20. The section 14 computes a demand value required for realizing a target speed. The section 16 adjusts an output of the engine 2 based on the demand value. The section 12 computes an expectation value based on the vehicle driving state and the driver's driving operation state. Based on a vehicle operating state including a comparison result of the demand value and the expectation value, the section 18 selects one of the demand value and the expectation value, and changes gears based on the selected value. As a result, driver's driving operation is prevented from becoming complicated during constant-speed-cruise control.

### BACKGROUND OF THE INVENTION

The present invention relates to a cruise control apparatus for a vehicle having a function of implementing constant-speed-cruise control for making the vehicle cruise at a target vehicle speed and transmission control for selecting an appropriate transmission gear based on the vehicle driving state and the driver's driving-operation state.

Through adjustment by a cruise control apparatus of the output of a vehicle engine such as an internal-combustion engine, a vehicle in which constant-speed-cruise control, i.e., so-called cruise control is implemented enables cruising at a target vehicle speed even when the driver keeps the accelerator pedal released (e.g., Japanese Laid-Open Patent Publication No. 11-257477).

In a technique according to Japanese Laid-Open Patent Publication No. 11-257477, engine-braking control and throttle opening degree control for constant-speed-cruise control are implemented based on the output of the engine while taking the actual acceleration of the vehicle into account. During the constant-speed cruise in particular, it is designed to realize through the throttle opening degree control a target rotation speed of the engine, while limiting the engine-braking control by means of the continuously variable transmission.

In Japanese Laid-Open Patent Publication No. 11-257477, switching between the constant-speed-cruise control and the normal-cruise control based on driver's driving operation is carried out only through switching of a constant-speed-cruise switch. However, with regard to the case where, during the constant-speed-cruise control, the driver implements the acceleration operation or the braking operation, Japanese Laid-Open Patent Publication No. 11-257477 does not disclose the level of a demand, from the viewpoint of the constant-speed-cruise control, for the acceleration or deceleration of the vehicle and the level of the driver's expectation for the acceleration or deceleration of the vehicle, and the way in which the differences in the levels are compensated for.

In particular, the compensation between the transmission control corresponding to the level of the demand, from the viewpoint of the constant-speed-cruise control, for the acceleration or deceleration of the vehicle and the transmission control corresponding to the level of the driver's expectation is not taken into account. Accordingly, because the transmission control is not appropriately implemented during the constant-speed-cruise control, whereby the target vehicle speed is not maintained sufficiently, a case is produced in which driver's operation is required. Therefore, as a result, driver's driving operation may be complicated.

### SUMMARY OF THE INVENTION

The objective of the present invention is to prevent driver's driving operation from becoming complicated by appropriately changing gears during constant-speed-cruise control.

To achieve the foregoing objective and in accordance with one aspect of the present invention, a vehicle cruise control apparatus is provided. The vehicle has an engine mounted thereon, a function of implementing constant-speed-cruise control for making the vehicle cruise at a constant target speed, and a function of implementing transmission control for selecting an appropriate transmission gear based on a driving state of the vehicle and a driver's driving operation state. The apparatus includes a demand value computation section, an output adjustment section, an expected value computation section, and a compensation and gear shift section. The demand value computation section computes a demand value required for realizing the target speed. The demand value includes braking force and driving force. The output adjustment section adjusts an output of the engine based on the demand value. The expected value computation section computes an expectation value based on the vehicle driving state and the driver's driving operation state. The expectation value is a value expected by the driver and includes braking force and driving force. Based on a vehicle operating state including a comparison result of the demand value and the expectation value, the compensation and gear shift section selects one of the demand value and the expectation value, and changes gears based on the selected value.

In accordance with another aspect of the present invention, a vehicle having an engine mounted thereon, a function of implementing constant-speed-cruise control for making the vehicle cruise at a constant target speed, and a function of implementing transmission control for selecting an appropriate transmission gear based on a driving state of the vehicle and a driver's driving operation state is provided. The vehicle includes a demand value computation section, an output adjustment section, an expected value computation section, and a compensation and gear shift section. The demand value computation section computes a demand value required for realizing the target speed. The demand value includes braking force and driving force. The output adjustment section adjusts an output of the engine based on the demand value. The expected value computation section computes an expectation value based on the vehicle driving state and the driver's driving operation state. The expectation value is a value expected by the driver and including braking force and driving force. Based on the vehicle operating state including a comparison result of the demand value and the expectation value, the compensation and gear shift section selects one of the demand value and the expectation value, and changes gears based on the selected value.

In accordance with a further aspect of the present invention a method for controlling a vehicle is provided. The vehicle implements constant-speed-cruise control for making the vehicle cruise at a constant target speed and transmission control for selecting an appropriate transmission gear based on a driving state of the vehicle and a driver's driving operation state. The method includes: computing a demand value required for realizing the target speed, the demand value including braking force and driving force; adjusting an output of the engine of the vehicle based on the demand value; computing an expectation value based on the vehicle driving state and the driver's driving operation state, the expectation value being a value expected by the driver and including braking force and driving force; selecting one of the demand value and the expectation value based on the vehicle operating state including a comparison result of the demand value and the expectation value; and changing gears based on the selected value.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram illustrating a configuration according to a first embodiment;

FIG. 2 is a block diagram illustrating a vehicle cruise control apparatus according to the first embodiment;

FIG. 3 is a flowchart illustrating part of functions of a compensation section and an AI-shift control section according to the first embodiment;

FIG. 4 is a timing chart representing one example of control according to the first embodiment;

FIG. 5 is a block diagram illustrating a vehicle cruise control apparatus according to a second embodiment;

FIG. 6 is a flowchart illustrating target-vehicle-speed limitation processing according to the second embodiment; and

FIG. 7 is a timing chart representing one example of control according to the second embodiment.

### DETAILED DESCRIPTION OF THE PREFERRED EMBODIMENTS

### First Embodiment

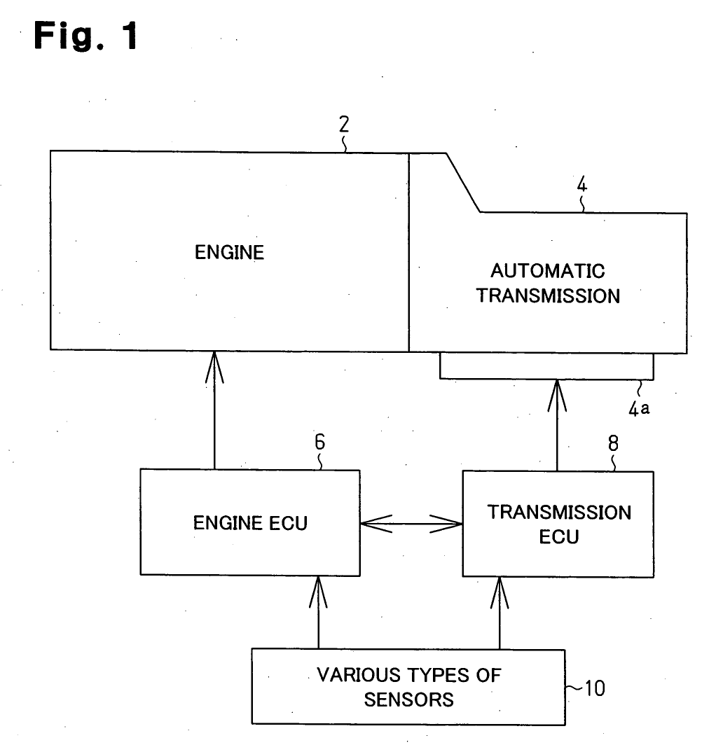

FIG. 1 is a block diagram illustrating a gasoline engine (referred to as an engine, hereinafter) 2, an automatic transmission 4, and electronic control units (ECUs) 6 and 8 for the engine 2 and the automatic transmission 4, respectively. The engine 2 is mounted, as a vehicle engine, in a vehicle. In addition, instead of the gasoline engine, a diesel engine or other types of engines may be utilized.

In a first embodiment, the engine 2 is provided with a plurality of cylinders, e.g., four cylinders. Respective fuel injection valves are provided in the intake ports of the cylinders. In each cylinder, fuel corresponding to the injection amount required by the engine 2 is injected from the fuel injection valve. Additionally, the engine 2 is provided with various types of sensors 10 such as an intake amount sensor, an accelerator pedal position sensor, a throttle opening degree sensor, an engine rotation speed sensor, a cylinder distinguishing sensor, a coolant temperature sensor, and an intake temperature sensor. Through the outputs of the foregoing sensors and by means of a brake pedal force sensor, a brake switch, and the like that are provided in the vehicle, the engine ECU 6 detects the operation state of the engine 2 and the driving state of the vehicle. Additionally, the engine ECU 6 communicates also with the transmission ECU 8. The engine ECU 6 and the transmission ECU 8 exchange commands and data items with each other. Based on the commands and data items, the engine ECU 6 controls the combustion state of the engine 2 through throttle opening degree control and fuel injection amount control.

The automatic transmission 4, which is a multi-speed transmission, is a torque-converter automatic transmission in which gears are changed by controlling the activation of internal rotational members, i.e., various types of gears such as planetary gears, clutches, and brakes. The various types of sensors 10 also include a shift-position sensor provided in the automatic transmission 4, an input shaft rotation speed sensor and an output shaft rotation speed sensor. Based on data items such as an accelerator pedal position ACCP, a throttle opening degree, an engine rotation speed NE, a shift position, an input shaft rotation speed Ni, and an output shaft speed No, the transmission ECU 8 detects the driver's driving-operation state, the inner state of the automatic transmission 4, and the vehicle driving state to implement the transmission control of the automatic transmission 4.

The transmission ECU 8 also reads the coolant temperature, the brake state, and the like among data items that are detected by the engine ECU 6. Additionally, as described above, the transmission ECU 8 communicates also with the engine ECU 6. The engine ECU 6 and the transmission ECU 8 exchange commands and data items with each other. Based on the commands and data items, the transmission ECU 8 implements the transmission control of the automatic transmission 4 by changing electromagnetic valves in a hydraulic pressure control circuit 4a. For example, with reference to a prestored gear shift curve, the transmission ECU 8 determines the gear stage of the automatic transmission 4 based on the vehicle speed SPD and the fuel injection amount (or the accelerator pedal position ACCP), and changes electromagnetic valves of the hydraulic pressure control circuit 4a so as to establish the determined gear stage.

In addition, the engine ECU 6 and the transmission ECU 8 are each configured mainly of a microcomputer having a CPU, a ROM that prestores various types of programs, maps, and the like, a RAM that temporarily stores computation results, a nonvolatile memory that retains computation results, prestored data, and the like, and an input-output interface.

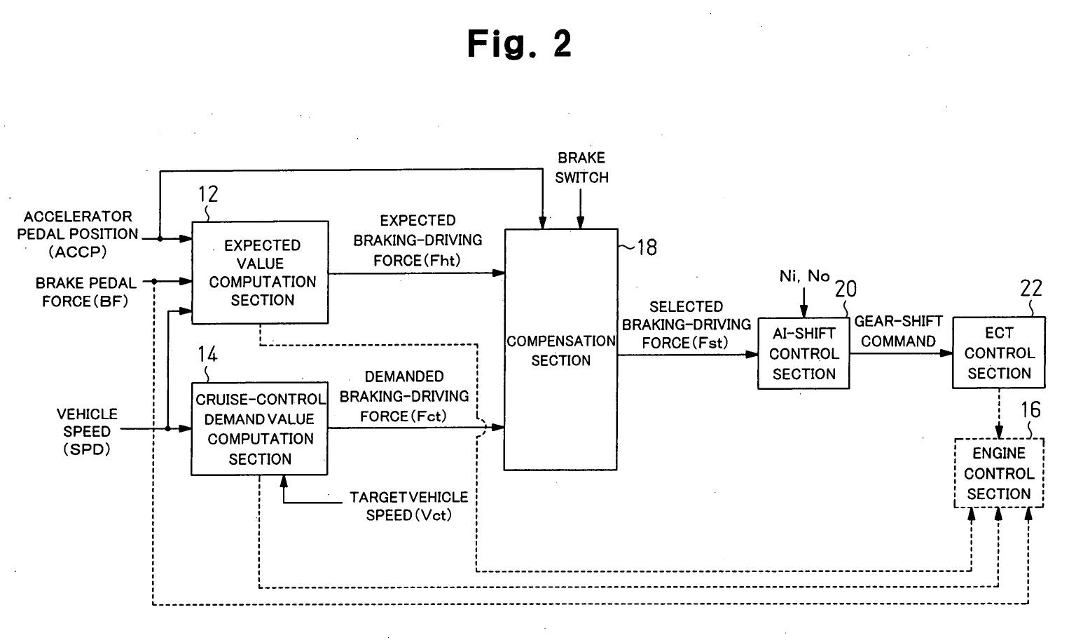

FIG. 2 is a block diagram illustrating a vehicle cruise control apparatus realized by means of both the ECUs 6 and 8. In FIG. 2, the part indicated by the solid lines relates to transmission control.

An expected value computation section 12 computes a expected braking-driving force Fht (in units of N), i.e., a driver's expectation value, based on the vehicle driving state and the driver's driving-operation state as the vehicle driving state, the vehicle speed SPD (computed based on the wheel rotation speed obtained from the output shaft rotation speed No) is utilized. As the driver's driving-operation state, the accelerator pedal position ACCP detected by the accelerator pedal position sensor and brake pedal force BF, i.e., brake-treading force detected by the brake pedal force sensor are utilized.

The expected braking-driving force Fht is computed from a map having as parameters the accelerator pedal position ACCP, the brake pedal force BF, and the vehicle speed SPD. When being positive, the expected braking-driving force Fht signifies driving force. When being negative, the expected braking-driving force Fht signifies braking force. Accordingly, when the expected braking-driving force Fht is positive, the driver expects the vehicle to be accelerated. When the expected braking-driving force Fht is negative, the driver expects the vehicle to be decelerated.

Based on the vehicle speed SPD detected by the vehicle speed sensor and a target vehicle speed Vct set in accordance with driver's instructing operation, a cruise-control demand value computation section 14 computes a force demanded in constant-speed-cruise control, or a demanded braking-driving force Fct (in units of N) for realizing the target vehicle speed Vct. Based on the difference between the vehicle speed SPD and the target vehicle speed Vct, the demanded braking-driving force Fct is computed through a map, equation calculation, or the like. When being positive, the demanded braking-driving force Fct signifies driving force. When being negative, the demanded braking-driving force Fct signifies braking force. Accordingly, it suggests that, when the demanded braking-driving force Fct is positive, the constant-speed-cruise control (cruise control) intends to accelerate the vehicle and when the demanded braking-driving force Fct is negative, the constant-speed-cruise control (cruise control) intends to decelerate the vehicle.

Based on the expected braking-driving force Fht, the demanded braking-driving force Fct, the brake pedal force BF, the output from an ECT control section 22 described later, and the like, an engine control section 16 implements engine control, as indicated by the broken lines, whereby output control of the engine 2 is carried out. In practice, the output of engine is enlarged or reduced through adjustment of the throttle opening degree and the fuel injection amount.

In contrast, at the transmission control side, a compensation section 18 selects, as indicated by the solid lines, the expected braking-driving force Fht or the demanded braking-driving force Fct, and then the selected Fht or Fct is set as selected braking-driving force Fst (in units of N). In this situation, the compensation section 18 implements the selection of the braking-driving force, in accordance with Table 1 below.

TABLE 1
SETTING OF SELECTED BRAKING-DRIVING FORCE Fst,
BASED ON EXPECTED BRAKING-DRIVING FORCE Fht
AND DEMANDED BRAKING-DRIVING FORCE Fct

| | DRIVER'S EXPECTATION | | |
|---|---|---|---|
| | | (B) | (C) |
| | | ACCELERATION | ACCELERATION |
| CONSTANT- | (A) | PEDAL OFF & | PEDAL OFF & |
| SPEED-CRUISE- | ACCELERATION | [BRAKE OFF OR Fht = | [BRAKE ON OR Fht < |
| CONTROL DEMAND | PEDAL ON | CREEP FORCE] | CREEP FORCE] |
| (a) ACCELERATION | Max (Fht, Fct) | Fct | Fht |
| DEMAND EXISTS | | | |
| (Fct ≧ 0) | | | |
| (b) NO DEMAND | Fht | Fht | Fht |
| | | (CREEP FORCE) | |
| (c) DECELERATION | Fht | Fct | Min (Fht, Fct) |
| DEMAND EXISTS | | | |
| (Fct < 0) | | | |

The compensation section 18 selects the braking-driving force and sets the selected braking-driving force Fst as follows.

(A) In the case where the driver's demand is acceleration (acceleration pedal ON).

(a) When the constant-speed-cruise control has the acceleration demand (Fct≧0), the expected braking-driving force Fht and the demanded braking-driving force Fct are compared with each other, and whichever is larger is selected and set as the selected braking-driving force Fst. In addition, “Max (Fht, Fct)” signifies an operator for selecting whichever is larger between the items in the parenthesis (if both are equal to each other, either one may be selected).

(b) When the constant-speed-cruise control has no demand, the expected braking-driving force Fht is selected and set as the selected braking-driving force Fst.

(c) When the constant-speed-cruise control has the deceleration demand (Fct<0), the expected braking-driving force Fht is selected and set as the selected braking-driving force Fst.

(B) In the case where the driver's demand is neither deceleration nor acceleration (acceleration pedal OFF and brake OFF, or Fht=creep force).

(a) When the constant-speed-cruise control has the acceleration demand (Fct≧0), the demanded braking-driving force Fct is selected and set as the selected braking-driving force Fst.

(b) When the constant-speed-cruise control has no demand, the expected braking-driving force Fht (=creep force) is selected and set as the selected braking-driving force Fst.

(c) When the constant-speed-cruise control has the deceleration demand (Fct<0), the demanded braking-driving force Fct is selected and set as the selected braking-driving force Fst.

(C) In the case where the driver's demand is deceleration (acceleration pedal OFF and brake ON, or Fht<creep force).

(a) When the constant-speed-cruise control has the acceleration demand (Fct≧0), the expected braking-driving force Fht is selected and set as the selected braking-driving force Fst.

(b) When the constant-speed-cruise control has no demand, the expected braking-driving force Fht is selected and set as the selected braking-driving force Fst.

(c) When the constant-speed-cruise control has the deceleration demand (Fct<0), the expected braking-driving force Fht and the demanded braking-driving force Fct are compared with each other, and whichever is smaller is selected and set as the selected braking-driving force Fst. In addition, “Min (Fht, Fct)” signifies an operator for selecting whichever is smaller between the items in the parenthesis (if both are equal to each other, either one may be selected).

With the foregoing relationship, the selected braking-driving force Fst is selected and inputted from the compensation section 18 to an AI-shift control section 20. Based on the selected braking-driving force Fst, the input shaft rotation speed Ni, and the output shaft rotation speed No, the AI-shift control section 20 outputs the gear-shift command to the ECT (Electronic Controlled Transmission) control section 22, thereby making the automatic transmission 4 set the appropriate gear stage.

In particular, in the case where (B) the driver's demand is neither deceleration nor acceleration and (c) the constant-speed-cruise control has the deceleration demand (Fct<0), the demanded braking-driving force Fct is selected and set as the selected braking-driving force Fst. However, when the vehicle comes to a downslope, the selected braking-driving force Fst (<0) is largely reduced. Accordingly, the present engine-braking force may not be able to realize sufficient selected braking-driving force Fst.

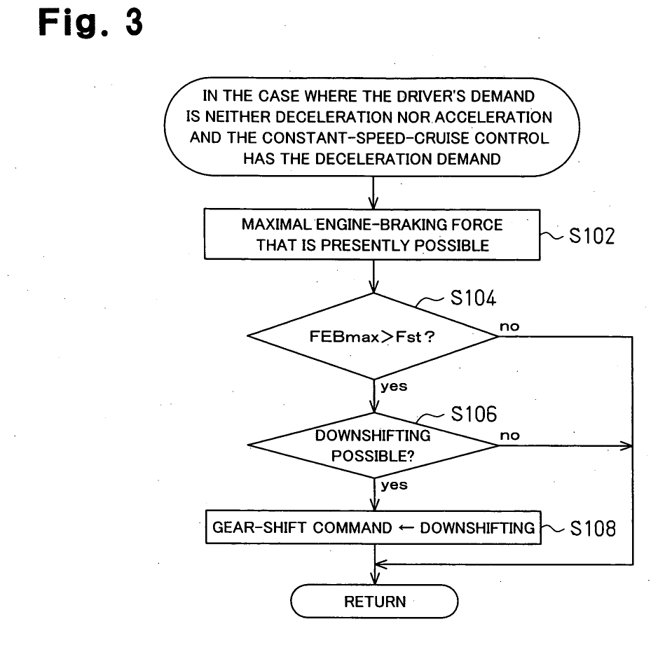

Thus, in the AI-shift control section 20, processing illustrated in FIG. 3 is implemented. The processing is periodically and recurrently implemented as long as the foregoing condition (B)-(c) is satisfied.

In the first place, maximal engine-braking force FEBmax [N], which is possible with the vehicle driving state including the present gear stage, is computed (in Step S102). The maximal engine-braking force FEBmax is maximal braking force, through engine braking, obtained based on the present gear stage and engine rotation speed, in the case where the throttle opening degree is made fully closed (0%) to cut off the supply of fuel. For example, for each gear stage, the maximal engine-braking force FEBmax is computed from a map, with the engine rotation speed NE utilized as a parameter. In addition, because it is braking force, the maximal engine-braking force FEBmax is set as a negative value. The larger the absolute value is, the larger the maximal engine-braking force FEBmax is.

Next, whether or not the maximal engine-braking force FEBmax is larger than the selected braking-driving force Fst is determined (in Step S104). If FEBmax≦Fst (“no” in Step S104), the processing is directly bypassed because, in terms of braking force, the selected braking-driving force Fst is the same as or smaller than the maximal engine-braking force FEBmax. In other words, as long as the engine-braking force can realize the selected braking-driving force Fst, the vehicle is not downshifted.

In contrast, if FEBmax≧Fst (“yes” in Step S104), whether or not downshifting for raising engine-braking force is possible is then determined (in Step S106). The determination is implemented, for example, based on whether or not a gear stage that is lower than the present gear stage exists. Moreover, a determination condition, i.e., whether or not the maximal engine-braking force FEBmax, computed under the condition that the vehicle is downshifted to that lower gear stage, is larger than the selected braking-driving force Fst may be added.

If the downshifting is possible (“yes” in Step S106), the processing is bypassed after that downshifting is set as the gear-shift command (in Step S108).

In contrast, if the downshifting is impossible (“no” in Step S106), the processing is bypassed without setting the gear-shift command. In the case where, as described above, the downshifting is impossible, the constant-speed-cruise control to be implemented thereafter cannot sufficiently reduce the vehicle speed. As a result, with the increase in the vehicle speed, the driver treads the brake pedal, whereby the vehicle speed is reduced and the constant-speed-cruise control is cancelled.

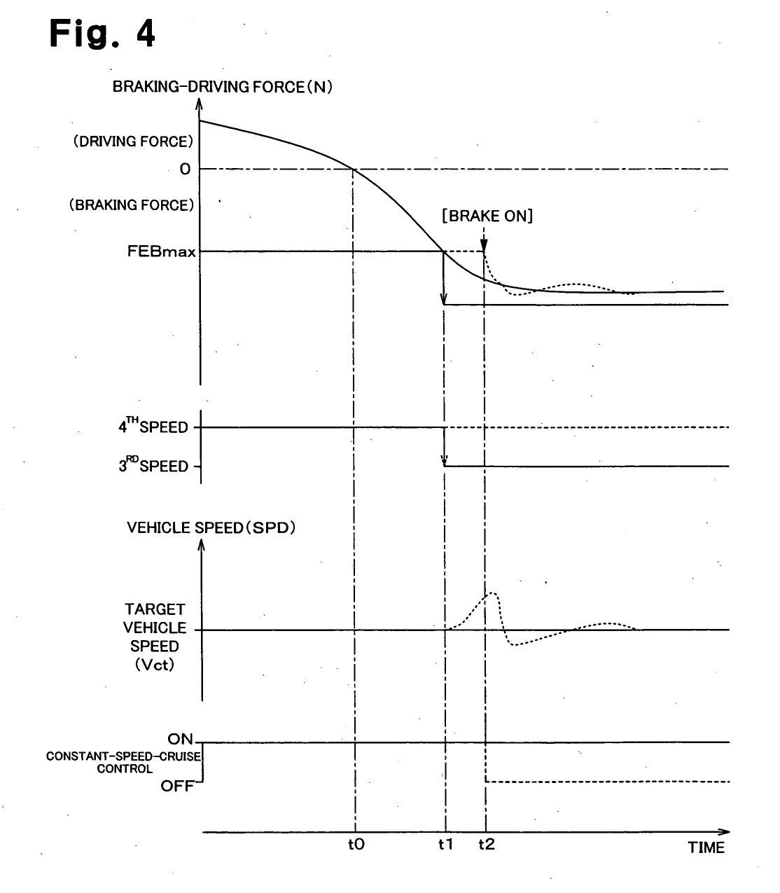

FIG. 4 is a timing chart representing one example of the processing illustrated in FIG. 3. A condition is represented in which, during the constant-speed-cruise control, the vehicle reaches a downslope and the braking-driving force (demanded braking-driving force Fct) is gradually reduced. Even though the braking-driving force is reduced from driving force (before t0) down to below zero [N], i.e., braking force (at and after t0), no gear shift for raising engine-braking force is implemented and the gear stage is maintained, as long as the maximal engine-braking force FEBmax is the same as or smaller than the selected braking-driving force Fst. In this case, the gear is maintained at the fourth gear.

However, when the maximal engine-braking force FEBmax becomes larger than the selected braking-driving force Fst, the gear is shifted down to the third gear (at t1). Accordingly, the maximal engine-braking force FEBmax is reduced. Therefore, even though the selected braking-driving force Fst is further reduced, that selected braking-driving force Fst can be realized as actual engine-braking force.

In consequence, the constant-speed-cruise control can maintain the target vehicle speed Vct, whereby it is made possible to avoid driver's braking operation due to the acceleration of the vehicle.

Provided the downshifting is not implemented during the constant-speed-cruise control, the maximal engine-braking force FEBmax does not become smaller than the selected braking-driving force Fst (after t1), whereby the vehicle is accelerated. Then, the driver implements braking operation (after t2) so as to reinstate the vehicle speed SPD that has been accelerated to the original speed. Accordingly, even when the fourth gear is maintained, the vehicle speed SPD is reduced and reinstated to the original speed. Additionally, because the start of the driver's braking operation (at t2) cancels the constant-speed-cruise control, the driver is required to implement setting operation again so as to activate the constant-speed-cruise control.

In claims, the expected value computation section 12, the cruise-control demand value computation section 14, the engine control section 16, and the compensation section 18 and the AI-shift control section 20 correspond to an expected value computation section, a demand value computation section, an output adjustment section, a compensation and gear shift section, respectively.

The first embodiment described above provides the following advantages.

(A) As represented in Table 1, the compensation section 18 selects the demanded braking-driving force Fct or the expected braking-driving force Fht, based on the vehicle operating state (the constant-speed-cruise-control setting state and the driver's driving-operation state) including the result of the comparison between the braking-driving forces Fct and Fht. Then, based on the selected braking-driving force Fst, the AI-shift control section 20 changes gears.

As discussed above, both the demanded braking-driving force Fct and the expected braking-driving force Fht are computed as equal-dimension braking-driving forces each including driving force and braking force. Therefore, easy and highly accurate comparison between the braking-driving forces Fct and Fht is enabled.

Therefore, in particular, in the case where, during the constant-speed-cruise control, the driver implements acceleration operation or braking operation, it is possible that, with regard to gear changing, an easy and highly accurate comparison between the constant-speed-cruise control and the driver's expectation can be made by comparing the demanded braking-driving force Fct with the expected braking-driving force Fht. Thus, in order to make the actual braking-driving force be in an appropriate condition, compensation between the constant-speed-cruise control and the driver's expectation is made with regard to gear changing.

Moreover, also in the period before the driver implements acceleration operation or braking operation, the constant-speed-cruise-control can appropriately represent braking demand because the demanded braking-driving force Fct represents not only driving force but also braking force. Thus, based on the braking demand represented by the selected braking-driving force Fst, the AI-shift control section 20 can change gears. Accordingly, during the constant-speed-cruise control, the AI-shift control section 20 can appropriately produce braking force through engine-braking force. Thus, the frequency of the case increases in which, without relying on the driver's braking operation, a constant-speed cruise is enabled.

In consequence, driver's driving operation can be prevented from becoming complicated by appropriately changing gears during constant-speed-cruise control.

(B) When, during the constant-speed-cruise control, the demanded braking-driving force Fct becomes negative, the AI-shift control section 20 determines that the engine braking is about to work. Moreover, the AI-shift control section 20 anticipates that, when the present engine-braking force cannot satisfy the demanded braking-driving force Fct, the driver implements braking operation and the driver's braking operation is reflected on the expected braking-driving force Fht.

Accordingly, in the case where the maximal engine-braking force FEBmax has not reached the selected braking-driving force Fst, the AI-shift control section 20 can maintain braking force that is equal to the demanded braking-driving force Fct by downshifting to enhance the engine-braking force.

As discussed above, by, during the constant-speed-cruise control, appropriately changing gears to maintain the target vehicle speed Vct, driver's braking operation can be dispensed with and the constant-speed-cruise control can be carried on. Therefore, it is possible to prevent driver's braking operation and the like from becoming complicated.

### Second Embodiment

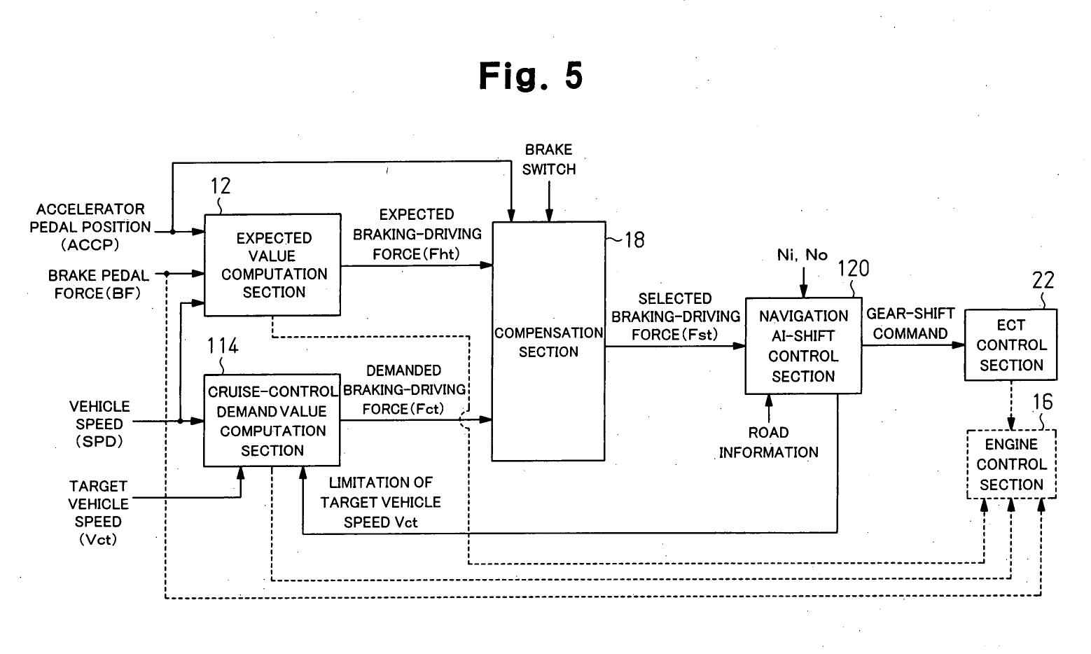

FIG. 5 is a block diagram illustrating a vehicle cruise control apparatus according to a second embodiment. The cruise-control demand value computation section 14 and the AI-shift control section 20 in the first embodiment are replaced by a new cruise-control demand value computation section 114 and a navigation-AI-shift control section 120, respectively. The rest of the configuration is the same as that in the first embodiment. Tike reference numerals denote like constituent elements.

The vehicle is equipped with a navigation system. The navigation-AI-shift control section 120 receives information on the road ahead of the vehicle, through map information for the navigation system. Then, the navigation-AI-shift control section 120 sets a recommended vehicle speed for the road along which the vehicle is about to travel. Based on the recommended vehicle speed, the navigation-AI-shift control section 120 limits the target vehicle speed Vct for the cruise-control demand value computation section 114. As the recommended vehicle speed, for example, the target vehicle turning speed set for a curve is utilized. In addition, other functions of the navigation-AI-shift control section 120 are the same as those of the AI-shift control section 20 in the first embodiment.

The cruise-control demand value computation section 114 limits the target vehicle speed Vct based on the recommended vehicle speed. In this case, when the target vehicle speed Vct set through the constant-speed-cruise control is higher than the recommended vehicle speed, the target vehicle speed Vct is set to the recommended vehicle speed. When being lower than the recommended vehicle speed, the target vehicle speed Vct set through the constant-speed-cruise control is maintained. In addition, the functions of the cruise-control demand value computation section 114 are the same as those of the cruise-control demand value computation section 14 in the first embodiment, except for the function of limiting the target vehicle speed Vct, based on the output of the navigation-AI-shift control section 120.

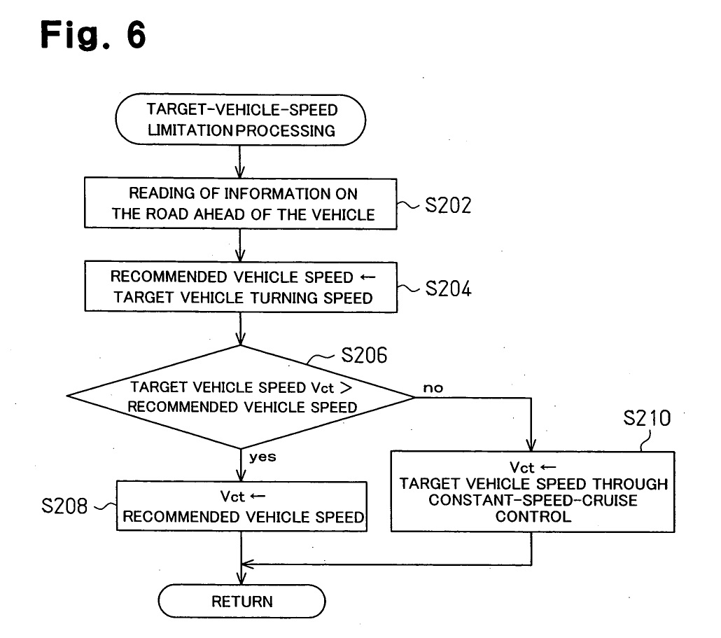

FIG. 6 is a flowchart illustrating a target-vehicle-speed limitation processing. The target-vehicle-speed limitation processing is implemented periodically and recurrently. When the target-vehicle-speed limitation processing is started, in the first place, the information on the road ahead of the vehicle is read from the map information for the navigation system (in Step S202). Then, the target vehicle turning speed set for the road ahead of the vehicle is set as the recommended vehicle speed (in Step S204). In addition, in the case where the target vehicle turning speed is not set for the road ahead of the vehicle, the recommended vehicle speed may be set to the legal speed limit or to a speed at which the vehicle can travel as fast as possible.

Next, whether or not the present target vehicle speed Vct is higher than the recommended vehicle speed is determined (in Step S206). If the target vehicle speed is higher than the recommended vehicle speed (“yes” in Step S206), the target vehicle speed Vct is set to the recommended vehicle speed (in Step S208). Accordingly, the target vehicle speed Vct is limited.

In contrast, if the target vehicle speed Vct is the same as or lower than the recommended vehicle speed (“no” in Step S206), the target vehicle speed is set to that target vehicle speed (in Step S210).

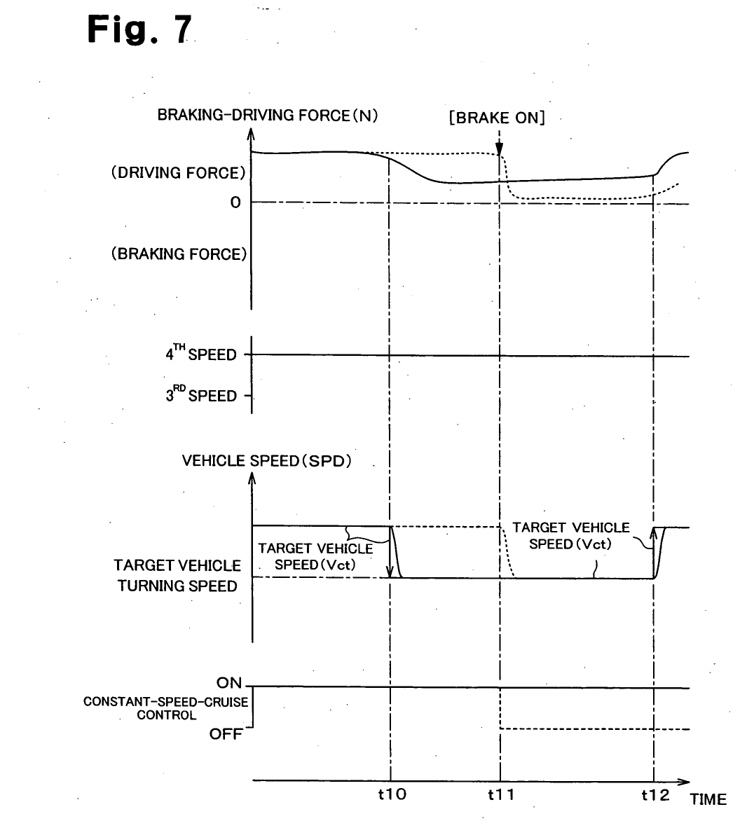

FIG. 7 is a timing chart representing one example of the processing according to the second embodiment. A case is represented in which, during the constant-speed-cruise control, the vehicle travels along a curve. Before the vehicle reaches the curve (before t10), the target vehicle speed Vct is at the initial level set through the constant-speed-cruise control.

When the vehicle reaches the curve (at t10), the target vehicle speed Vct is limited by the target vehicle turning speed set in the information on the road ahead of the vehicle. In FIG. 7, because the target vehicle speed Vct at the time immediately prior to t10 is higher than the target vehicle turning speed, the target vehicle speed Vct is set to the target vehicle turning speed so that the target vehicle speed Vct is limited so as not to exceed the target vehicle turning speed.

Accordingly, the vehicle speed SPD is automatically lowered through the constant-speed-cruise control (after t10). Thus, because the driver senses no discomfort at the curve, the driver's braking operation can be prevented.

After the vehicle passes the curve (after t12), the target vehicle speed Vct for constant-speed-cruise control is recovered, whereby the constant-speed-cruise control without discomfort can be maintained.

If, during the constant-speed-cruise control, the vehicle speed is not reduced at the curve, the driver who senses discomfort during the travel of the vehicle along the curve implements braking operation, as indicated by the broken line (after t11). Accordingly, because, even though the vehicle speed SPD is reduced, the start (at t11) of the driver's braking operation concurrently cancels the constant-speed-cruise control, the driver is required to implement setting operation again so as to reactivate the constant-speed-cruise control.

In claims, the expected value computation section 12 and the cruise-control demand value computation section 114 correspond to an expected value computation section and a demand value computation section, respectively. Additionally, the engine control section 16, the compensation section 18, and the navigation-AI-shift control section 120 correspond to an output adjustment section, a compensation and gear shift section, and a target speed limiting section, respectively.

The second embodiment provides the following advantages.

(A) The advantage of the first embodiment is obtained.

(B) Even though, during the constant-speed-cruise control, the target vehicle speed Vct is maintained, road conditions such as a curve and the like may cause the driver to implement braking operation for safety's sake. In the case where road information causes the foregoing situation to be anticipated, the navigation-AI-shift control section 120 limits the target vehicle speed Vct in advance based on the recommended vehicle speed that is set corresponding to the road information.

Accordingly, even when the constant-speed-cruise control is being implemented at a target vehicle speed Vct that is higher than the recommended vehicle speed for a road along which the vehicle is about to travel, the vehicle speed is lowered through the reduction of the engine output or, further, through gear changing, whereby the cruise supported by the constant-speed-cruise control can be maintained. Thus, it is possible not only to prevent driver's braking operation and the like from becoming complicated but also to prevent control hunting between the constant-speed-cruise control and the speed lowering processing.

### Another Embodiment

(a) To the determination condition (FEBmax>Fst) in Step S104 in FIG. 3, another condition that, even though FEBmax is the same as or smaller than Fst, FEBmax becomes larger than Fst in a short time based on change with time of the selected braking-driving force Fst may be added in such a way that the determination condition and that another condition makes a logical sum. The addition of that another condition to make the logical sum allows anticipation that FEBmax becomes larger than Fst in a short time, whereby the engine-braking force can rapidly be enhanced through downshifting. Therefore, smooth constant-speed-cruise control is enabled.

1. A vehicle cruise control apparatus, the vehicle having an engine mounted thereon, a function of implementing constant-speed-cruise control for making the vehicle cruise at a constant target speed and a function of implementing transmission control for selecting an appropriate transmission gear based on a driving state of the vehicle and a driver's driving operation state, the apparatus comprising:
a demand value computation section that computes a demand value required for realizing the target speed, the demand value including braking force and driving force;
an output adjustment section that adjusts an output of the engine based on the demand value;
an expected value computation section that computes an expectation value based on the vehicle driving state and the driver's driving operation state, the expectation value being a value expected by the driver and including braking force and driving force; and
a compensation and gear shift section that, based on a vehicle operating state including a comparison result of the demand value and the expectation value, selects one of the demand value and the expectation value, and changes gears based on the selected value.

2. The apparatus according to claim 1, wherein the vehicle operating state includes the comparison result, the demand value, and the driver's driving operation state.

3. The apparatus according to claim 1, wherein, when it is difficult, during the constant-speed-cruise control, to realize the selected value through adjustment of only the output by the output adjustment section, the compensation and gear shift section realizes the selected value by changing gears.

4. The apparatus according to claim 3, wherein, when the selected value is the braking force and it is difficult to realize the braking force through adjustment of only the output by the output adjustment section, the compensation and gear shift section downshifts.

5. The apparatus according to claim 2, wherein, when, during the constant-speed-cruise control, the expectation value and the driver's driving operation state demand neither acceleration nor deceleration, and the demand value is the braking force, the compensation and gear shift section selects the braking force, and wherein, when it is difficult to realize the braking force through adjustment of only the output by the output adjustment section, the compensation and gear shift section downshifts.

6. The apparatus according to claim 5, wherein, when the braking force cannot be realized by a maximum engine braking force computed based on the vehicle driving state, the compensation and gear shift section downshifts.

7. The apparatus according to claim 1, further comprising a target speed limiting section that, based on road information, sets a recommended speed of the vehicle when traveling on a road ahead, and wherein, based on the recommended speed, the target speed limiting section limits the target speed in the constant-speed-cruise control.

8. The apparatus according to claim 7, wherein the recommended speed is a target turning speed that is set for a curve of the road in the road information.

9. The apparatus according to claim 8, wherein, when the vehicle has passed the curve, the target speed limiting section cancels the limitation on the target speed.

10. The apparatus according to claim 7, wherein the target speed limiting section receives the road information from a navigation system mounted on the vehicle.

11. The apparatus according to claim 1, wherein the vehicle has a multi-speed transmission, and the transmission control is executed for controlling the multi-speed transmission.

12. A vehicle having an engine mounted thereon, a function of implementing constant-speed-cruise control for making the vehicle cruise at a constant target speed and a function of implementing transmission control for selecting an appropriate transmission gear based on a driving state of the vehicle and a driver's driving operation state, the vehicle comprising:
a demand value computation section that computes a demand value required for realizing the target speed, the demand value including braking force and driving force;
an output adjustment section that adjusts an output of the engine based on the demand value;
an expected value computation section that computes an expectation value based on the vehicle driving state and the driver's driving operation state, the expectation value being a value expected by the driver and including braking force and driving force; and
a compensation and gear shift section that, based on the vehicle operating state including a comparison result of the demand value and the expectation value, selects one of the demand value and the expectation value, and changes gears based on the selected value.

13. A method for controlling a vehicle, the vehicle implementing constant-speed-cruise control for making the vehicle cruise at a constant target speed and transmission control for selecting an appropriate transmission gear based on a driving state of the vehicle and a driver's driving operation state, the method comprising:
computing a demand value required for realizing the target speed, the demand value including braking force and driving force;
adjusting an output of the engine of the vehicle based on the demand value;
computing an expectation value based on the vehicle driving state and the driver's driving operation state, the expectation value being a value expected by the driver and including braking force and driving force;
selecting one of the demand value and the expectation value based on the vehicle operating state including a comparison result of the demand value and the expectation value; and
changing gears based on the selected value.
